(19) United States
(12) Patent Application Publication
(10) Pub. No.: US 2017/0003776 A1
(43) Pub. Date: Jan. 5, 2017

(54) DYNAMIC ESTIMATION OF GROUND CONDITION IN A CAPACITIVE SENSING DEVICE

(71) Applicant: SYNAPTICS INCORPORATED, San Jose, CA (US)

(72) Inventor: Petr SHEPELEV, Campbell, CA (US)

(21) Appl. No.: 14/788,476

(22) Filed: Jun. 30, 2015

(51) Int. Cl. G06F 3/044

(52) U.S. Cl. CPC G06F 3/044

(57) ABSTRACT

In an example, a processing system for a capacitive sensing device includes a sensor module comprising sensor circuitry configured to drive a plurality of sensor electrodes with modulated signals to acquire resulting signals from the plurality of sensor electrodes. The processing system includes a determination module configured to compare a plurality of measurements determined from the resulting signals against a first threshold corresponding to a satisfactory ground condition and a second threshold corresponding to an interference metric. The determination module is further configured to adjust a sensing threshold based on a number of particular measurements of the plurality of measurements that satisfy the second threshold and fail to satisfy the first threshold.

### BACKGROUND

Field of the Disclosure

Embodiments of disclosure generally relate to capacitive sensing and, more particularly, to interference mitigation in a capacitive sensing device.

Description of the Related Art

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

### SUMMARY

Techniques for dynamic estimation of ground condition in a capacitive sensing device. In an embodiment, a processing system for a capacitive sensing device includes a sensor module comprising sensor circuitry configured to drive a plurality of sensor electrodes with modulated signals to acquire resulting signals from the plurality of sensor electrodes. The processing system includes a determination module configured to compare a plurality of measurements determined from the resulting signals against a first threshold corresponding to a satisfactory ground condition and a second threshold corresponding to an interference metric. The determination module is further configured to adjust a sensing threshold based on a number of particular measurements of the plurality of measurements that satisfy the second threshold and fail to satisfy the first threshold.

In an embodiment, an integrated display device and capacitive sensing device includes a plurality of display electrodes, a plurality of sensor electrodes, each of the plurality of sensor electrodes comprising at least one of the display electrodes, and a processing system. The processing system is configured to drive the plurality of sensor electrodes with modulated signals to acquire resulting signals from the plurality of sensor electrodes, and drive at least a portion of the plurality of display electrodes with a guarding signal. The processing system is further configured to compare a plurality of measurements determined from the resulting signals against a first threshold corresponding to a satisfactory ground condition and a second threshold corresponding to an interference metric. The processing system is further configured to adjust a sensing threshold based on a number of particular measurements of the plurality of measurements that satisfy the second threshold and fail to satisfy the first threshold.

In an embodiment, a method of operating a capacitive sensing device includes drive a plurality of sensor electrodes with modulated signals to acquire resulting signals from the plurality of sensor electrodes; comparing a plurality of measurements determined from the resulting signals against a first threshold corresponding to a satisfactory ground condition and a second threshold corresponding to an interference metric; and adjusting a sensing threshold based on a number of particular measurements of the plurality of measurements that satisfy the second threshold and fail to satisfy the first threshold.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of an exemplary input device, according to one embodiment described herein.

FIGS. 2A-2B illustrate portions of exemplary patterns of sensing elements according to embodiments described herein.

FIG. 3 is a flow diagram depicting a method of operating a capacitive sensing device according to an embodiment.

To facilitate understanding, identical reference numerals have been used, where possible, to designate identical elements that are common to the figures. It is contemplated that elements disclosed in one embodiment may be beneficially utilized on other embodiments without specific recitation. The drawings referred to here should not be understood as being drawn to scale unless specifically noted. Also, the drawings are often simplified and details or components omitted for clarity of presentation and explanation. The drawings and discussion serve to explain principles discussed below, where like designations denote like elements.

### DETAILED DESCRIPTION

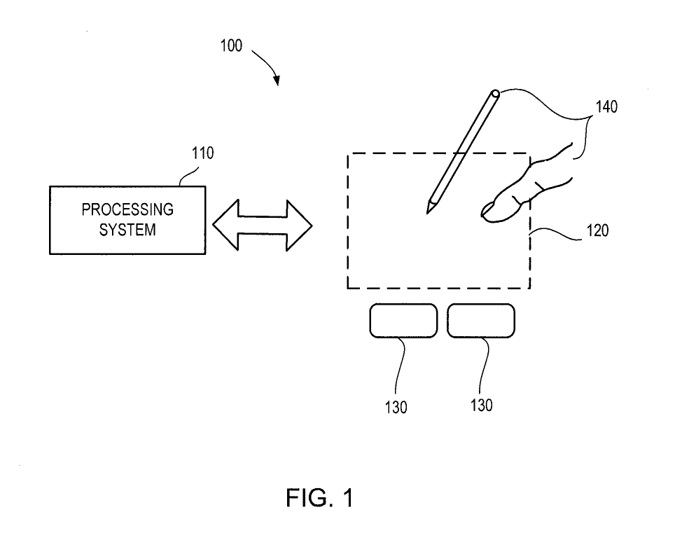

FIG. 1 is a block diagram of an exemplary input device 100, in accordance with embodiments of the invention. The input device 100 may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device 100 and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device 100 can be implemented as a physical part of the electronic system, or can be physically separate from the electronic system. As appropriate, the input device 100 may communicate with parts of the electronic system using any one or more of the following: buses, networks, and other wired or wireless interconnections. Examples include I²C, SPI, PS/2, Universal Serial Bus (USB), Bluetooth, RF, and IRDA.

In FIG. 1, the input device 100 is shown as a proximity sensor device (also often referred to as a “touchpad” or a “touch sensor device”) configured to sense input provided by one or more input objects 140 in a sensing region 120. Example input objects include fingers and styli, as shown in FIG. 1.

Sensing region 120 encompasses any space above, around, in and/or near the input device 100 in which the input device 100 is able to detect user input (e.g., user input provided by one or more input objects 140). The sizes, shapes, and locations of particular sensing regions may vary widely from embodiment to embodiment. In some embodiments, the sensing region 120 extends from a surface of the input device 100 in one or more directions into space until signal-to-noise ratios prevent sufficiently accurate object detection. The distance to which this sensing region 120 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g. a touch surface) of the input device 100, contact with an input surface of the input device 100 coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region 120 has a rectangular shape when projected onto an input surface of the input device 100.

The input device 100 may utilize any combination of sensor components and sensing technologies to detect user input in the sensing region 120. The input device 100 comprises one or more sensing elements for detecting user input. As several non-limiting examples, the input device 100 may use capacitive, elastive, resistive, inductive, magnetic, acoustic, ultrasonic, and/or optical techniques.

Some implementations are configured to provide images that span one, two, three, or higher dimensional spaces. Some implementations are configured to provide projections of input along particular axes or planes.

In some capacitive implementations of the input device 100, voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g. system ground), and by detecting the capacitive coupling between the sensor electrodes and input objects.

Some capacitive implementations utilize “mutual capacitance” (or “transcapacitance”) sensing methods based on changes in the capacitive coupling between sensor electrodes. In various embodiments, an input object near the sensor electrodes alters the electric field between the sensor electrodes, thus changing the measured capacitive coupling. In one implementation, a transcapacitive sensing method operates by detecting the capacitive coupling between one or more transmitter sensor electrodes (also “transmitter electrodes” or “transmitters”) and one or more receiver sensor electrodes (also “receiver electrodes” or “receivers”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. A resulting signal may comprise effect(s) corresponding to one or more transmitter signals, and/or to one or more sources of environmental interference (e.g. other electromagnetic signals). Sensor electrodes may be dedicated transmitters or receivers, or may be configured to both transmit and receive.

In FIG. 1, a processing system 110 is shown as part of the input device 100. The processing system 110 is configured to operate the hardware of the input device 100 to detect input in the sensing region 120. The processing system 110 comprises parts of or all of one or more integrated circuits (ICs) and/or other circuitry components. For example, a processing system for a mutual capacitance sensor device may comprise transmitter circuitry configured to transmit signals with transmitter sensor electrodes, and/or receiver circuitry configured to receive signals with receiver sensor electrodes). In some embodiments, the processing system 110 also comprises electronically-readable instructions, such as firmware code, software code, and/or the like. In some embodiments, components composing the processing system 110 are located together, such as near sensing element(s) of the input device 100. In other embodiments, components of processing system 110 are physically separate with one or more components close to sensing element(s) of input device 100, and one or more components elsewhere. For example, the input device 100 may be a peripheral coupled to a desktop computer, and the processing system 110 may comprise software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes.

In some embodiments, the processing system 110 responds to user input (or lack of user input) in the sensing region 120 directly by causing one or more actions. Example actions include changing operation modes, as well as GUI actions such as cursor movement, selection, menu navigation, and other functions. In some embodiments, the processing system 110 provides information about the input (or lack of input) to some part of the electronic system (e.g. to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions.

For example, in some embodiments, the processing system 110 operates the sensing element(s) of the input device 100 to produce electrical signals indicative of input (or lack of input) in the sensing region 120. The processing system 110 may perform any appropriate amount of processing on the electrical signals in producing the information provided to the electronic system. For example, the processing system 110 may digitize analog electrical signals obtained from the sensor electrodes. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device 100 is implemented with additional input components that are operated by the processing system 110 or by some other processing system. These additional input components may provide redundant functionality for input in the sensing region 120, or some other functionality. FIG. 1 shows buttons 130 near the sensing region 120 that can be used to facilitate selection of items using the input device 100. Other types of additional input components include sliders, balls, wheels, switches, and the like. Conversely, in some embodiments, the input device 100 may be implemented with no other input components.

In some embodiments, the input device 100 comprises a touch screen interface, and the sensing region 120 overlaps at least part of an active area of a display screen. For example, the input device 100 may comprise substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 100 and the display screen may share physical elements. For example, some embodiments may utilize some of the same electrical components for displaying and sensing. As another example, the display screen may be operated in part or in total by the processing system 110.

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media readable by the processing system 110). Additionally, the embodiments of the present invention apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

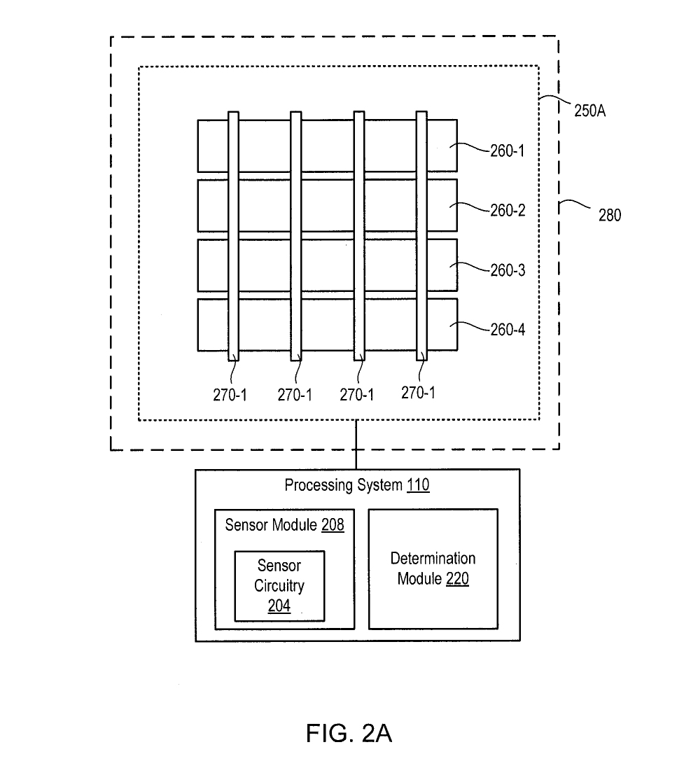

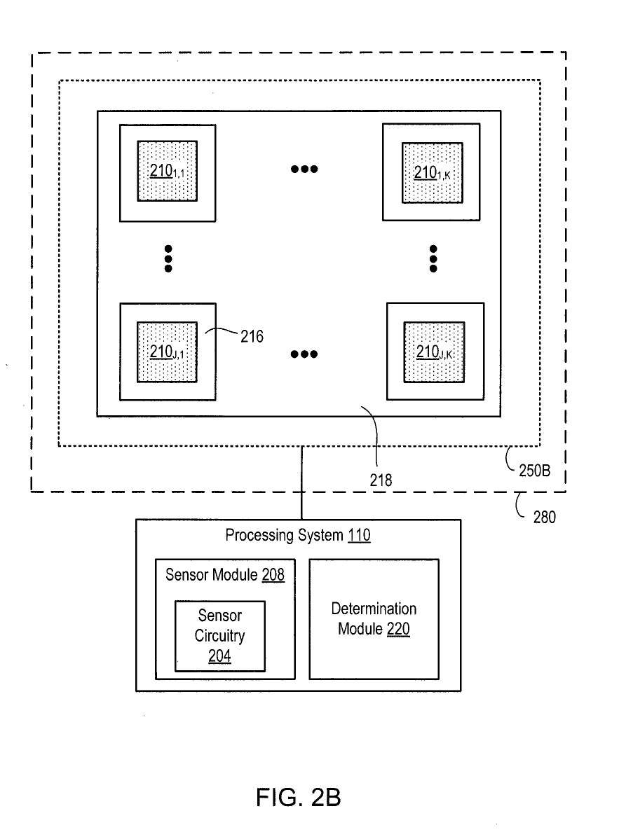

FIG. 2A illustrates a portion of an exemplary pattern of sensing elements according to some embodiments. For clarity of illustration and description, FIG. 2A shows the sensing elements in a pattern of simple rectangles and does not show various components, such as various interconnects between the sensing elements and the processing system 110. An electrode pattern 250A comprises a first plurality of sensor electrodes 260 (260-1, 260-2, 260-3, . . . 260-n), and a second plurality of sensor electrodes 270 (270-1, 270-2, 270-3, . . . 270-m) disposed over the first plurality of electrodes 260. In the example shown, n=m=4, but in general n and m are each positive integers and not necessarily equal to each other. In various embodiments, the first plurality of sensor electrodes 260 are operated as a plurality of transmitter electrodes (referred to specifically as “transmitter electrodes 260”), and the second plurality of sensor electrodes 270 are operated as a plurality of receiver electrodes (referred to specifically as “receiver electrodes 270”). In another embodiment, one plurality of sensor electrodes may be configured to transmit and receive and the other plurality of sensor electrodes may also be configured to transmit and receive. Further processing system 110 receives resulting signals with one or more sensor electrodes of the first and/or second plurality of sensor electrodes while the one or more sensor electrodes are modulated with absolute capacitive sensing signals. The first plurality of sensor electrodes 260, the second plurality of sensor electrodes 270, or both can be disposed within the sensing region 120. The electrode pattern 250A can be coupled to the processing system 110.

The first plurality of electrodes 260 and the second plurality of electrodes 270 are typically ohmically isolated from each other. That is, one or more insulators separate the first plurality of electrodes 260 and the second plurality of electrodes 270 and prevent them from electrically shorting to each other. In some embodiments, the first plurality of electrodes 260 and the second plurality of electrodes 270 are separated by insulative material disposed between them at cross-over areas; in such constructions, the first plurality of electrodes 260 and/or the second plurality of electrodes 270 can be formed with jumpers connecting different portions of the same electrode. In some embodiments, the first plurality of electrodes 260 and the second plurality of electrodes 270 are separated by one or more layers of insulative material. In such embodiments, the first plurality of electrodes 260 and the second plurality of electrodes 270 can be disposed on separate layers of a common substrate. In some other embodiments, the first plurality of electrodes 260 and the second plurality of electrodes 270 are separated by one or more substrates; for example, the first plurality of electrodes 260 and the second plurality of electrodes 270 can be disposed on opposite sides of the same substrate, or on different substrates that are laminated together. In some embodiments, the first plurality of electrodes 260 and the second plurality of electrodes 270 can be disposed on the same side of a single substrate.

The areas of localized capacitive coupling between the first plurality of sensor electrodes 260 and the second plurality sensor electrodes 270 may be form “capacitive pixels” of a “capacitive image.” The capacitive coupling between sensor electrodes of the first and second pluralities 260 and 270 changes with the proximity and motion of input objects in the sensing region 120. Further, in various embodiments, the localized capacitive coupling between each of the first plurality of sensor electrodes 260 and the second plurality of sensor electrodes 270 and an input object may be termed “capacitive pixels” of a “capacitive image.” In some embodiments, the localized capacitive coupling between each of the first plurality of sensor electrodes 260 and the second plurality of sensor electrodes 270 and an input object may be termed “capacitive measurements” of “capacitive profiles.”

The processing system 110 can include a sensor module 208 having sensor circuitry 204. The sensor module 208 operates the electrode pattern 250A receive resulting signals from electrodes in the electrode pattern using a capacitive sensing signal having a sensing frequency. The processing system 110 can include a determination module 220 configured to determine capacitive measurements from the resulting signals. The determination module 220 can track changes in capacitive measurements to detect input object(s) in the sensing region 120. The processing system 110 can include other modular configurations, and the functions performed by the sensor module 208 and the determination module 220 can, in general, be performed by one or more modules in the processing system 110. The processing system 110 can include modules, and can perform other functions as described in some embodiments below.

The processing system 110 can operate in absolute capacitive sensing mode or transcapacitive sensing mode. In absolute capacitive sensing mode, receiver(s) in the sensor circuitry 204 measure voltage, current, or charge on sensor electrode(s) in the electrode pattern 250A while the sensor electrode(s) are modulated with absolute capacitive sensing signals to generate the resulting signals. The determination module 220 generates absolute capacitive measurements from the resulting signals. The determination module 220 can track changes in absolute capacitive measurements to detect input object(s) in the sensing region 120.

In transcapacitive sensing mode, transmitter(s) in the sensor circuitry 204 drive one or more of the first plurality of electrodes 260 with the capacitive sensing signal (also referred to as a transmitter signal or modulated signal in the transcapacitive sensing mode). Receiver(s) in the sensor circuitry 204 measure voltage, current, or charge on one or more of the second plurality of electrodes 270 to generate the resulting signals. The resulting signals comprise the effects of the capacitive sensing signal and input object(s) in the sensing region 120. The determination module 220 generates transcapacitive measurements from the resulting signals. The determination module 220 can track changes in transcapacitive measurements to detect input object(s) in the sensing region 120.

In some embodiments, the processing system 110 “scans” the electrode pattern 250A to determine capacitive measurements. In the transcapacitive sensing mode, the processing system 110 can drive the first plurality of electrodes 260 to transmit transmitter signal(s). The processing system 110 can operate the first plurality of electrodes 260 such that one transmitter electrode transmits at one time, or multiple transmitter electrodes transmit at the same time. Where multiple transmitter electrodes transmit simultaneously, these multiple transmitter electrodes may transmit the same transmitter signal and effectively produce a larger transmitter electrode, or these multiple transmitter electrodes may transmit different transmitter signals. For example, multiple transmitter electrodes may transmit different transmitter signals according to one or more coding schemes that enable their combined effects on the resulting signals of the second plurality of electrodes 270 to be independently determined. In the absolute capacitive sensing mode, the processing system 110 can receiving resulting signals from one sensor electrode 260, 270 at a time, or from a plurality of sensor electrodes 260, 270 at a time. In either mode, the processing system 110 can operate the second plurality of electrodes 270 singly or collectively to acquire resulting signals. In absolute capacitive sensing mode, the processing system 110 can concurrently drive all electrodes along one or more axes. In some examples, the processing system 110 can drive electrodes along one axis (e.g., along the first plurality of sensor electrodes 260) while electrodes along another axis are driven with a shield signal, guard signal, or the like. In some examples, some electrodes along one axis and some electrodes along the other axis can be driven concurrently.

In the transcapacitive sensing mode, the processing system 110 can use the resulting signals to determine capacitive measurements at the capacitive pixels. A set of measurements from the capacitive pixels form a “capacitive image” (also “capacitive frame”) representative of the capacitive measurements at the pixels. The processing system 110 can acquire multiple capacitive images over multiple time periods, and can determine differences between capacitive images to derive information about input in the sensing region 120. For example, the processing system 110 can use successive capacitive images acquired over successive periods of time to track the motion(s) of one or more input objects entering, exiting, and within the sensing region 120.

In absolute capacitive sensing mode, the processing system 110 can use the resulting signals to determine capacitive measurements along an axis of the sensor electrodes 260 and/or an axis of the sensor electrodes 270. A set of such measurements forms a “capacitive profile” representative of the capacitive measurements along the axis. The processing system 110 can acquire multiple capacitive profiles along one or both of the axes over multiple time periods and can determine differences between capacitive profiles to derive information about input in the sensing region 120. For example, the processing system 110 can use successive capacitive profiles acquired over successive periods of time to track location or proximity of input objects within the sensing region 120. In other embodiments, each sensor can be a capacitive pixel of a capacitive image and the absolute capacitive sensing mode can be used to generate capacitive image(s) in addition to or in place of capacitive profiles.

The baseline capacitance of the input device 100 is the capacitive image or capacitive profile associated with no input object in the sensing region 120. The baseline capacitance changes with the environment and operating conditions, and the processing system 110 can estimate the baseline capacitance in various ways. For example, in some embodiments, the processing system 110 takes “baseline images” or “baseline profiles” when no input object is determined to be in the sensing region 120, and uses those baseline images or baseline profiles as estimates of baseline capacitances. The determination module 220 can account for the baseline capacitance in the capacitive measurements and thus the capacitive measurements can be referred to as “delta capacitive measurements”. Thus, the term “capacitive measurements” as used herein encompasses delta-measurements with respect to a determined baseline.

In some touch screen embodiments, at least one of the first plurality of sensor electrodes 260 and the second plurality of sensor electrodes 270 comprise one or more display electrodes of a display device 280 used in updating a display of a display screen, such as one or more segments of a “Vcom” electrode (common electrodes), gate electrodes, source electrodes, anode electrode and/or cathode electrode. These display electrodes may be disposed on an appropriate display screen substrate. For example, the display electrodes may be disposed on a transparent substrate (a glass substrate, TFT glass, or any other transparent material) in some display screens (e.g., In Plane Switching (IPS) or Plane to Line Switching (PLS) Organic Light Emitting Diode (OLED)), on the bottom of the color filter glass of some display screens (e.g., Patterned Vertical Alignment (PVA) or Multi-domain Vertical Alignment (MVA)), over an emissive layer (OLED), etc. The display electrodes can also be referred to as “combination electrodes,” since the display electrodes perform functions of display updating and capacitive sensing. In various embodiments, each sensor electrode of the first and second plurality of sensor electrodes 260 and 270 comprises one or more combination electrodes. In other embodiments, at least two sensor electrodes of the first plurality of sensor electrodes 260 or at least two sensor electrodes of the second plurality of sensor electrodes 270 may share at least one combination electrode. Furthermore, in one embodiment, both the first plurality of sensor electrodes 260 and the second plurality electrodes 270 are disposed within a display stack on the display screen substrate. Additionally, at least one of the sensor electrodes 260, 270 in the display stack may comprise a combination electrode. However, in other embodiments, only the first plurality of sensor electrodes 260 or the second plurality of sensor electrodes 270 (but not both) are disposed within the display stack, while other sensor electrodes are outside of the display stack (e.g., disposed on an opposite side of a color filter glass).

In an embodiment, the processing system 110 comprises a single integrated controller, such as an application specific integrated circuit (ASIC), having the sensor module 208, the determination module 220, and any other module(s). In another embodiment, the processing system 110 can include a plurality of integrated circuits, where the sensor module 208, the determination module 220, and any other module(s) can be divided among the integrated circuits. For example, the sensor module 208 can be on one integrated circuit, and the determination module 220 and any other module(s) can be one or more other integrated circuits. In some embodiments, a first portion of the sensor module 208 can be on one integrated circuit and a second portion of the sensor module 208 can be on second integrated circuit. In such embodiments, at least one of the first and second integrated circuits comprises at least portions of other modules such as a display driver module and/or a display driver module.

FIG. 2B illustrates a portion of another exemplary pattern of sensing elements according to some embodiments. For clarity of illustration and description, FIG. 2B presents the sensing elements in a matrix of rectangles and does not show various components, such as various interconnects between the processing system 110 and the sensing elements. An electrode pattern 250B comprises a plurality of sensor electrodes 210 disposed in a rectangular matrix. The electrode pattern 250B comprises sensor electrodes 210_{J,K} (referred to collectively as sensor electrodes 210) arranged in J rows and K columns, where J and K are positive integers, although one or J and K may be zero. It is contemplated that the electrode pattern 250B may comprise other patterns of the sensor electrodes 210, such as polar arrays, repeating patterns, non-repeating patterns, non-uniform arrays a single row or column, or other suitable arrangement. Further, the sensor electrodes 210 may be any shape, such as circular, rectangular, diamond, star, square, noncovex, convex, nonconcave concave, etc. Further, the sensor electrodes 210 may be sub-divided into a plurality of distinct sub-electrodes. The electrode pattern 250 is coupled to the processing system 110.

The sensor electrodes 210 are typically ohmically isolated from one another. Additionally, where a sensor electrode 210 includes multiple sub-electrodes, the sub-electrodes may be ohmically isolated from each other. Furthermore, in one embodiment, the sensor electrodes 210 may be ohmically isolated from a grid electrode 218 that is between the sensor electrodes 210. In one example, the grid electrode 218 may surround one or more of the sensor electrodes 210, which are disposed in windows 216 of the grid electrode 218. The grid electrode 218 may be used as a shield or to carry a guarding signal for use when performing capacitive sensing with the sensor electrodes 210. Alternatively or additionally, the grid electrode 218 may be used as sensor electrode when performing capacitive sensing. Furthermore, the grid electrode 218 may be co-planar with the sensor electrodes 210, but this is not a requirement. For instance, the grid electrode 218 may be located on a different substrate or on a different side of the same substrate as the sensor electrodes 210. The grid electrode 218 is optional and in some embodiments, the grid electrode 218 is not present.

In a first mode of operation, the processing system 110 can use at least one sensor electrode 210 to detect the presence of an input object via absolute capacitive sensing. The sensor module 208 can measure voltage, charge, or current on sensor electrode(s) 210 to obtain resulting signals indicative of a capacitance between the sensor electrode(s) 210 and an input object. The determination module 222 uses the resulting signals to determine absolute capacitive measurements. When the electrode pattern 250B, the absolute capacitive measurements can be used to form capacitive images.

In a second mode of operation, the processing system 110 can use groups of the sensor electrodes 210 to detect presence of an input object via transcapacitive sensing. The sensor module 208 can drive at least one of the sensor electrodes 210 with a transmitter signal, and can receive a resulting signal from at least one other of the sensor electrodes 210. The determination module 222 uses the resulting signals to determine transcapacitive measurements and form capacitive images.

The input device 100 may be configured to operate in any one of the modes described above. The input device 100 may also be configured to switch between any two or more of the modes described above. The processing system 110 can be configured as described above with respect to FIG. 2A.

As used herein, “system ground” may indicate a common voltage shared by system components. For example, a capacitive sensing system of a mobile phone can, at times, be referenced to a system ground provided by the phone's power source (e.g., a charger or battery). The system ground may not be fixed relative to earth or any other reference. For example, a mobile phone on a table usually has a floating system ground. A mobile phone being held by a person who is strongly coupled to earth ground through free space may be grounded relative to the person, but the person-ground may be varying relative to earth ground. In many systems, the system ground is connected to, or provided by, the largest area electrode in the system.

In various embodiments, the ground condition of the input device corresponds to free-space capacitive coupling in series between the input device-universe and the input object-universe. In various embodiments, when the coupling between the input device and the universe (free-space coupling coefficient), is relatively small, the device may be considered to be in a low ground mass state. However, when the coupling between the capacitive sensing device and the universe is substantially larger, the device may be considered to be operating in a good ground mass state. Further, when the coupling between an input object and system ground of the input device is substantially large, the input device may be in a good ground mass condition.

When the grounding condition of the input device or electronic system is low or otherwise non-optimal (e.g., when the input device is lying on a desk, rather than being held by a user), the device/system is said to be in an low-ground mass (LGM) condition. One approach to compensating for an LGM condition is lowering the sensing threshold regardless the actual ground condition of the device. The sensing threshold is used to indicate whether an input object is present or not present. Measurements above the sensing threshold indicate an input object, and capacitive measurements below the sensing threshold do not indicate an input object. A higher sensing threshold lowers device sensitivity, and a lower sensing threshold increases device sensitivity.

Operating with a static sensing threshold can result in degradation in system performance. While the sensing threshold can be set for optimal sensitivity during an LGM condition, the static sensing threshold can cause excess sensitivity under a better ground condition. Setting the sensing threshold for optimal sensitivity in good ground condition can fail to detect input object(s) in an LGM condition. In embodiments described herein, the sensing threshold is adjusted dynamically based on the number of capacitive measurements that satisfy a threshold range. Such dynamic adjustment of the sensing threshold results in optimal performance in both LGM and better ground conditions.

In general, LGM can decrease the amplitude of the capacitive measurements in the presence of input object(s). The attenuation coefficient is a function of the capacitance of the device to space (Cdevice) and combination (e.g., sum) of capacitances between the input object(s) and the sensor electrodes (SUM(Cinput)). For example, the attenuation coefficient can be SUM(Cinput)/Cdevice. The form of the attenuation coefficient depends at least in part on the sensor circuitry. The form of the attenuation coefficient can be derived analytically, simulated with a model, or measured empirically. While the combination of capacitances between the input object(s) and the sensor electrodes is described as a sum, other mathematical combinations can be used (e.g., averages, weighted averages, etc.).

The capacitance of the device to space (Cdevice) is a function of the dimensions of the device and hence Cdevice can be determined during the design phase. Thus, during operation, the processing system 110 can estimate SUM(Cinput) in order to determine the attenuation coefficient. Having calculated the attenuation coefficient due to LGM, the processing system 110 can adjust threshold related to sensitivity of detection.

In an embodiment, the processing system 110 employs a first threshold corresponding to a satisfactory ground condition (TTgg), and a second threshold corresponding to an interference metric (Tfloor). Below Tfloor, the capacitive measurements for input object(s) cannot be reliably distinguished from interference. The processing system 110 can adjust the second threshold as interference is detected and measured. Above TTgg, the device has a better ground and the LGM effects can be considered negligible. A “good” ground condition can be predetermined and tuned for the particular device. Between Tfloor and TTgg, the processing system 110 determines the attenuation coefficient in order to adjust sensitivity and compensate for the LGM condition. The processing system 110 can perform the thresholding operation for all sensor electrodes, for individual groups of sensor electrodes, or for sensor electrodes individually.

In an embodiment, during operation, the processing system 110 determines whether capacitive measurements derived from sensor electrodes are above Tfloor and below TTgg. If so, the processing system 110 counts the number of sensor electrodes that satisfy this condition and computes SUM(Cinput). Given Cdevice, the processing system 110 can determine the attenuation coefficient due to LGM. Given the attenuation coefficient due to LGM, the processing system 110 can adjust the sensing threshold. Thus, the processing system 110 adjusts the sensing threshold based on a number of particular measurements that satisfy the second threshold (Tfloor) and fail to satisfy the first threshold (TTgg). In one embodiment, the sensing threshold can be adjusted if at least one measurement satisfies the second threshold (Tfloor) and all measurements fail to satisfy the first threshold (TTgg).

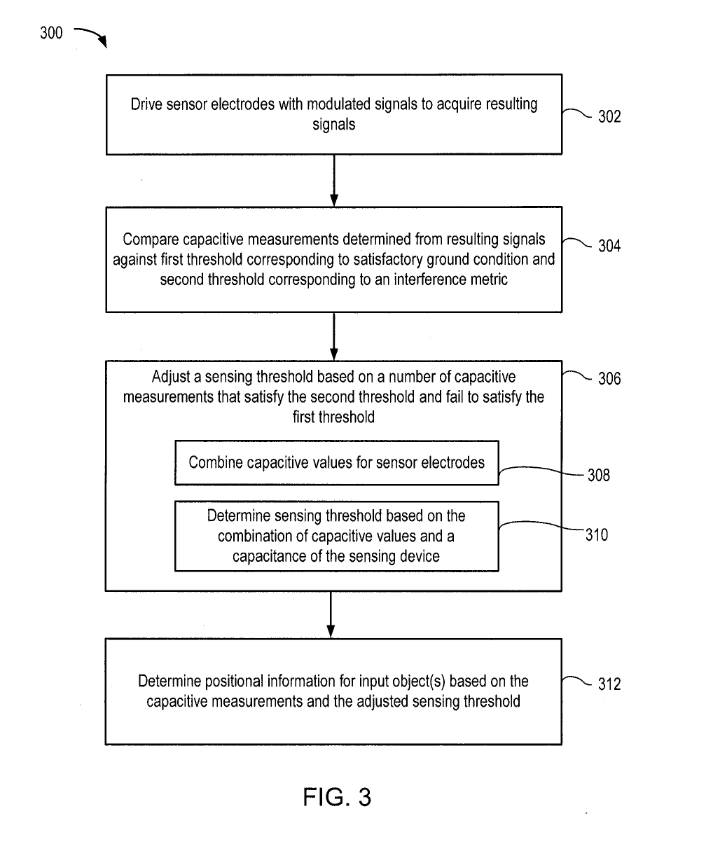

FIG. 3 is a flow diagram depicting a method 300 of operating a capacitive sensing device according to an embodiment. The method 300 can be performed by the input device 100 described above. The input device 100 can be configured with the sensor pattern 250A of FIG. 2A or the sensor pattern 250B of FIG. 2B. In an embodiment, the input device 100 can be integrated with a display and, as such, some of the sensor electrodes can also be display electrodes. In other embodiments, the input device 100 is not integrated with a display.

At block 302, the processing system 110 drives a plurality of sensor electrodes with modulated signals to acquire resulting signals. Example electrodes include the sensor electrodes 260 and 270 in the pattern 250A, or the sensor electrodes 210 in the pattern 250B. In an embodiment, the sensor electrodes comprise at least one display electrode of the display device 280. In an embodiment, the display electrode(s) also used for capacitive sensing comprise at least one common electrode of the display device 280. In an embodiment, the processing system 110 drives other sensor electrode(s) with a guarding signal while driving the plurality of sensor electrodes with modulated signals. In an embodiment, the input device 100 is integrated with a display device 280, and the processing system 110 drives at least one display electrode of the display device 280 with a guarding signal while driving the plurality of sensor electrodes with the modulated signals.

At block 304, the processing system 110 compares capacitive measurements (a plurality of measurements) determined from the resulting signals against a first threshold corresponding to a satisfactory ground condition and a second threshold corresponding to an interference metric. For example, the processing system 110 can compare the plurality of measurements against the “good ground” threshold TTgg and the interference threshold Tfloor, as described above. Measurements above the good ground threshold TTgg are not affected by an LGM condition, and measurements below the interference threshold Tfloor cannot be reliably distinguished from noise. The capacitive measurements can be transcapacitive measurements or absolute capacitive measurements.

At block 306, the processing system 110 adjusts a sensing threshold based on a number of particular capacitive measurements that satisfy the second threshold and fail to satisfy the first threshold. That is, the processing system 110 determines the number of measurements that are between the good ground threshold and the interference threshold and adjusts the sensing threshold accordingly. For example, the processing system 110 can increase the sensing threshold (e.g., increase sensitivity) as more measurements are between the first and second thresholds (e.g., indicative of an LGM condition). The processing system 110 can decrease sensitivity as fewer measurements are between the first and second threshold (e.g., indicative of a good ground condition).

In an example, block 306 can include a block 308, where the processing system 110 combines capacitive values for the sensor electrodes. For example, the processing system 110 can sum the capacitive values to compute SUM(Cinput) described above. At block 310, the processing system 110 can determine the sensing threshold based on the combination of the capacitive values and a capacitance of the capacitive sensing device (e.g., Cdevice). That is, the processing system 110 can determine the attenuation coefficient as described above, which is generally a function of the device capacitance to free space and the sum of the capacitance between the input object(s) and the sensor electrodes.

At block 312, the processing system 110 can determine positional information for input object(s) based on the capacitive measurements and the adjusted sensing threshold.

The embodiments and examples set forth herein were presented in order to best explain the embodiments in accordance with the present technology and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

In view of the foregoing, the scope of the present disclosure is determined by the claims that follow.

We claim:

1. A processing system for a capacitive sensing device, comprising:
a sensor module comprising sensor circuitry configured to drive a plurality of sensor electrodes with modulated signals to acquire resulting signals from the plurality of sensor electrodes; and
a determination module configured to:
compare a plurality of measurements determined from the resulting signals against a first threshold corresponding to a satisfactory ground condition and a second threshold corresponding to an interference metric; and
adjust a sensing threshold based on a number of particular measurements of the plurality of measurements that satisfy the second threshold and fail to satisfy the first threshold.

2. The processing system of claim 1, wherein the plurality of measurements comprise capacitance values for sensor electrodes in the plurality of sensor electrodes that provide the particular resulting signals, and wherein the determination module is configured to combine the capacitance values.

3. The processing system of claim 2, wherein the determination module is configured to adjust the sensing threshold based on both the combination of the capacitance values and a capacitance of the capacitive sensing device.

4. The processing system of claim 1, wherein the first threshold corresponding to the satisfactory ground condition is predetermined for the capacitive sensing device.

5. The processing system of claim 1, wherein the determination module is configured to determine positional information for at least one input object based on the plurality of measurements and the adjusted sensing threshold.

6. The processing system of claim 1, wherein each of the plurality of sensor electrodes comprises at least one display electrode of a display device.

7. The processing system of claim 6, wherein the at least one display electrode of each of the plurality of sensor electrodes comprises at least one common electrode of the display device.

8. The processing system of claim 1, wherein the capacitive sensing device is integrated with a display device, and wherein at least one display electrode of the display device is driven with a guarding signal while the plurality of sensor electrodes is driven with the modulated signals.

9. The processing system of claim 1, wherein the plurality of sensor electrodes are disposed in a matrix of sensor electrodes.

10. The processing system of claim 1, wherein the sensor circuitry is configured to drive at least one additional sensor electrode with a guarding signal while driving the plurality of sensor electrodes with the modulated signals.

11. An integrated display device and capacitive sensing device, comprising:
a plurality of display electrodes;
a plurality of sensor electrodes, each of the plurality of sensor electrodes comprising at least one of the display electrodes; and
a processing system configured to:
drive the plurality of sensor electrodes with modulated signals to acquire resulting signals from the plurality of sensor electrodes;
drive at least a portion of the plurality of display electrodes with a guarding signal;
compare a plurality of measurements determined from the resulting signals against a first threshold corresponding to a satisfactory ground condition and a second threshold corresponding to an interference metric;
adjust a sensing threshold based on a number of particular measurements of the plurality of measurements that satisfy the second threshold and fail to satisfy the first threshold.

12. The device of claim 11, wherein the plurality of measurements comprise capacitance values for sensor electrodes in the plurality of sensor electrodes that provide the particular resulting signals, and wherein the processing system is configured to combine the capacitance values.

13. The device of claim 12, wherein the processing system is configured to adjust the sensing threshold based on both the combination of the capacitance values and a capacitance of the integrated display device and capacitive sensing device.

14. The device of claim 11, wherein the processing system is configured to determine positional information for at least one input object based on the plurality of measurements and the adjusted sensing threshold.

15. The device of claim 11, wherein the at least one display electrode of each of the plurality of sensor electrodes comprises at least one common electrode of the plurality of display electrodes.

16. The device of claim 11, wherein the plurality of sensor electrodes are disposed in a matrix of sensor electrodes.

17. A method of operating a capacitive sensing device, comprising:
drive a plurality of sensor electrodes with modulated signals to acquire resulting signals from the plurality of sensor electrodes;
comparing a plurality of measurements determined from the resulting signals against a first threshold corresponding to a satisfactory ground condition and a second threshold corresponding to an interference metric; and
adjusting a sensing threshold based on a number of particular measurements of the plurality of measurements that satisfy the second threshold and fail to satisfy the first threshold.

18. The method of claim 17, wherein the plurality of measurements comprise capacitance values for sensor electrodes in the plurality of sensor electrodes that provide the particular resulting signals, and wherein the operation of adjusting the sensing threshold comprises:
combining the capacitance values.

19. The method of claim 18, wherein the operation of adjusting the sensing threshold comprises:
determining the sensing threshold based on the combination of the capacitance values and a capacitance of the capacitive sensing device.

20. The method of claim 17, further comprising:
determining positional information for at least one input object based on the resulting signals and the adjusted sensing threshold.
